(19) United States
(12) Patent Application Publication
(10) Pub. No.: US 2009/0002297 A1
(43) Pub. Date: Jan. 1, 2009

(54) IMAGE DISPLAY DEVICE

(75) Inventors: Hiroshi Sakai, Kanagawa (JP); Daikichi Morohashi, Tokyo (JP); Takeshi Nakane, Tokyo (JP); Kazuya Yamanaka, Tokyo (JP); Susumu Kobayashi, Saitama (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 12/174,205

(22) Filed: Jul. 16, 2008

Related U.S. Application Data
(63) Continuation of application No. PCT/JP2006/315522, filed on Aug. 4, 2006.

(30) Foreign Application Priority Data
Jan. 17, 2006 (JP) 2006-008959

(51) Int. Cl. G09G 3/36

(52) U.S. Cl. 345/87

(57) ABSTRACT

In an image display device, each frame image in input image signals is divided into multiple subfield images according to the number of pixels to be shifted by a pixel shifting part (3), the subfield images are supplied to an spatial light modulation part (2) to spatially modulate light from a light source part (1), and the pixels of the spatial light modulation part are shifted by the pixel shifting part (3) in sync with said subfield images to display an image. The image display device has an image processing part (5) supplying to a spatial light modulation part (2) a smaller or larger number of subfield images than the number of the divided subfield images so that the display frame rate of the spatial light modulation part (2) is equal to the frame rate of the input image signals.

### CROSS-REFERENCE TO RELATED APPLICATION

The present application is a Continuing Application based on International Application PCT/JP2006/315522 filed on Aug. 4, 2006, which, in turn, claims the priority from Japanese Patent Application No. 2006-8959 filed on Jan. 17, 2006, the entire disclosure of these earlier applications being herein incorporated by reference.

### TECHNICAL FIELD

The present invention relates to an image display device such as a projector, FMD (face mounted display), HMD (head mounted display), and electronic viewer.

### BACKGROUND OF THE INVENTION

Image display devices in which light from a light source is modulated by a spatial light modulation device such as a transmissive or reflective liquid crystal panel or DMD (digital micromirror device) according to images to be displayed and the modulated light is enlarged and projected on a screen by a projection optical system conventionally utilize the field-sequential single plate system in which a single spatial light modulation device is used to display R, G, and B color images in an field-sequential manner or the multiple plate system in which R, G, and B dedicated spatial light modulation devices are used to display R, G, and B color image simultaneously.

Furthermore, in many of the above image display devices, the display pixel positions of the spatial light modulation device are selectively shifted using a pixel shifting means having liquid crystal cells and birefringent plates so as to increase the apparent pixel number for high resolution (for example, see Japanese Laid-Open Patent Application Publication No. 2005-57457).

In the image display device in which the above pixel shifting is performed, a frame of input image signals are divided into multiple subfields according to the number of pixels to be shifted for display. If the subfield division rate is low, flicker due to the pixel shifting is visible, deteriorating the image quality.

The present inventors conducted an experiment to determine at what display frame rate the flicker due to pixel shifting is invisible and obtained the results shown in the table below. The experiment was conducted as follow. An array of LEDs was formed. Each LED was assumed to be a pixel obtained by the pixel shifting. The LEDs were individually turned on and visually evaluated.

| display frame rate | |
|---|---|
| (Hz) | result |
| 30 | x |
| 40 | Δ |
| 45 | + |
| 60 | ++ |

x 80% of people cannot tolerate the flicker due to pixel shifting;
Δ 70% of people can tolerate the flicker due to pixel shifting;
+ 80% of people can tolerate the flicker due to pixel shifting; and
++ 90% of people can tolerate the flicker due to pixel shifting.

From the above experimental results, at least 40 Hz or higher display frame rate is necessary for making the flicker due to pixel shifting less visible.

However, when a spatial light modulation device having a high display frame rate is simply used to increase the subfield division rate for high speed pixel shifting in order to make the flicker due to pixel shifting less visible, there may be time frames in which no image is displayed because the display frame rate and the frame rate of input image signals do not match.

On the other hand, in the field-sequential single plate system, R, G, and B color images should be created at the shifted pixel positions in an field-sequential manner. If the field-sequential images are rewritten at a low rate, namely if the field sequential rate is low, color breakup occurs, deteriorating the image quality.

### SUMMARY OF THE INVENTION

Therefore, an object of the present invention, which has been made in view of such circumstances, is to provide an image display device constantly displaying high quality images particularly with the flicker due to pixel shifting being less visible.

The first aspect of the invention, which achieves the object described above, is an image display device in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image, wherein the device has an image processing part supplying to said spatial light modulation part a smaller or larger number of said subfield images than the number of said divided subfield images so that the display frame rate of said spatial light modulation part is equal to the frame rate of said input image signals.

The second aspect of the invention resides in the image display device according to the first aspect, wherein said pixel shifting part performs the four pixel shifting; and said image processing part supplies to said spatial light modulation part three subfield images in a frame period of said input image signals.

The third aspect of the invention resides in the image display device according to the second aspect, wherein the frame rate of said input image signals is 60 Hz and the display frame rate of said subfield images is 180 Hz.

The forth aspect of the invention resides in the image display device according to the first aspect, wherein said pixel shifting part shifts pixels in a specific shifting order and said image processing part supplies to said spatial light modulation part subfield images corresponding to the shifted pixel positions of sequentially supplied frame images in accordance with the pixel position shifted by said pixel shifting part.

The fifth aspect of the invention, which achieves the object described above, is an image display method in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image, wherein a larger or smaller number of said subfield images than the number of said divided subfield images are supplied to said spatial light modulation part to display an image so that the display frame rate of said spatial light modulation part is equal to the frame rate of said input image signals.

The sixth aspect of the invention, which achieves the object described above, is an image display method in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image, wherein said pixel shifting is performed in a specific shifting sequence and a frame image in said input image signals is updated at least once in a cycle of said pixel shifting.

According to the present invention, the image processing part of the image display device supplies to the spatial light modulation part a smaller or larger number of the subfield images than the number of the divided subfield images so that the display frame rate of said spatial light modulation part is equal to the frame rate of said input image signal. Therefore, high quality images can constantly be displayed particularly with the flicker due to pixel shifting being less visible.

### BRIEF DESCRIPTION OF THE DRAWINGS

FIG. 1 is a block diagram showing the basic structure of the image display device of the present invention;

FIG. 2 is an illustration schematically showing the structure of the image display device of Reference Example 1;

FIG. 3 is an block diagram showing the core part structure of the image processing part shown in FIG. 2;

FIG. 4 is an illustration showing subfields divided by the subfield division part shown in FIG. 3;

FIG. 5 is an timing chart showing the operation of the image display device of Reference Example 1;

FIG. 6 is an illustration for explaining the four-pixel shifting in Reference Example 1;

FIG. 7 is an block diagram showing the core part structure of the image processing part of the image display device of Reference Example 2;

FIG. 8 is a block diagram showing the core part structure of the image processing part of the image display device of Reference Example 3;

FIG. 9 is a timing chart showing the operation of the image display device of Reference Example 4;

FIG. 10 is a timing chart showing the operation of the image display device of Reference Example 5;

FIG. 11 is a timing chart showing the operation of the image display device of Reference Example 6;

FIG. 12 is a block diagram showing the core part structure of the image processing part of the image display device of Embodiment 1;

FIG. 13 is a timing chart showing the operation of Embodiment 1;

FIG. 14 is an illustration schematically showing the structure of the image display device of Reference Example 7;

FIG. 15 is a block diagram showing the structure of the image processing part of Reference Example 7;

FIG. 16 is a timing chart showing the operation of Reference Example 7;

FIG. 17 is a timing chart showing the operation of an image display device developed along with the present invention; and

FIG. 18 is a timing chart showing the operation of another image display device developed along with the present invention.

### LEGEND

1 light source part
2 spatial light modulation part
3 pixel shifting part
4 projection optical system
5 image processing part
5a first image processing part
5b second image processing part
11 white light source
12 reflector
13 color wheel
14 P/S converter
16 transmissive LCD
16R R transmissive LCD
16G G transmissive LCD
16B B transmissive LCD
17A, 17B liquid crystal cell
18A, 18B birefringent plate
19 screen
51 memory
52 memory controller
53 subfield division part
54 frame rate measuring part
55 pixel shifting rate determination part
56 clock generation part
57 input interface (I/F)
58 field-sequential conversion part
59 liquid crystal cell control part
60 internal oscillator
61 IP conversion part
62 LCD controller

### DESCRIPTION OF THE PREFERRED EMBODIMENTS

The image display device of the present invention will be described hereafter with reference to the drawings.

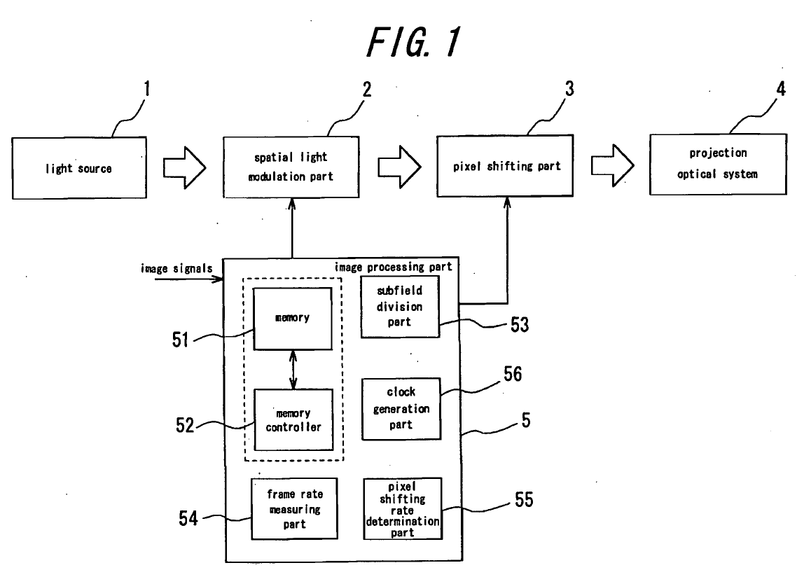

FIG. 1 is a block diagram showing the basic structure of the image display device of the present invention. The image display device shown in FIG. 1 has a light source part 1, a spatial light modulation part 2, a pixel shifting part 3, a projection optical system 4, and an image processing part 5 controlling the spatial light modulation part 2 and pixel shifting part 3. Illumination light emitted from the light source part 1 is spatially modulated by the spatial light modulation part 2 based on input image signals supplied to the image processing part 5, subject to selective pixel shifting at the pixel shifting part 3, and projected and displayed on a not-shown screen by the projection optical system 4.

The image processing part 5 has a memory 51, a memory controller 52, a subfield division part 53, a frame rate measuring part 54, a pixel shifting rate determination part 55, and a clock generation part 56.

More specifically, the light source part 1 consists of a white light source such as an ultra high pressure (UHP) mercury lamp and halogen lamp and a color separation element such as a dichroic mirror or consists of three (R, G, and B) or more color LED light sources in the multiple plate system. The light source part 1 consists of a white light source and a color separation element such as a color wheel or consists of a multicolor LED light source in the single plate system.

The spatial light modulation part 2 consists of a spatial light modulation device such as a transmissive or reflective liquid crystal (LCD) and DMD (digital micromirror device) in the single plate system and consists of three of them in the multiple plate system. The pixel shifting part 3 consists of liquid crystal cells such as TN liquid crystal and ferroelectric liquid crystal cells as a polarization rotation element, and birefringent plates formed by anisotropic crystal such as quartz, lithium niobate, rutile, calcite, and Chilean nitrate as a light deflection element.

Specific reference examples of the image display device of the present invention will be described hereafter.

### Reference Example 1

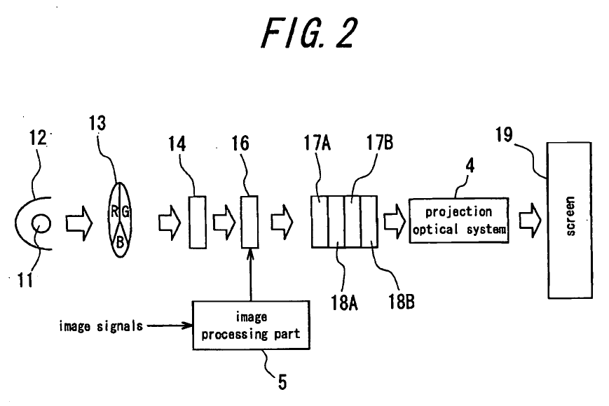

FIG. 2 is an illustration schematically showing the image display device of Reference Example 1 developed with the present invention. This image display device utilizes an field-sequential single plate system in which a single spatial light modulation device is used to display three primary colors in an field-sequential manner. The light source part has a white light source 11 such as an UHP lamp, a reflector 12, a not-shown integrator illumination optical system for example using a fly's eye lens, a color wheel 13 rotated for converting white light to three, R, G, and B, primary colors in an field-sequential manner, a not-shown lens for efficiently guiding the white light emerging from the integrator illumination optical system to the color wheel 13, and a P/S converter 14 as a polarization conversion means for aligning the planes of polarization of light emerging from the color wheel 13.

The spatial light modulation part has a collective-writing type transmissive LDC 16 as a spatial light modulation device, reading and displaying field-sequential data supplied from the image processing part 5.

As for the transmissive LCD 16, those having a field sequential rate of 360 Hz, 480 Hz, 540 Hz, or 720 Hz are known. Those having higher rates are preferable for efficiently reducing color breakup. However, those having a field sequential rate of 720 Hz are expensive and unaffordable. Therefore, an inexpensive and affordable transmissive LCD having a field sequential rate of 480 Hz is used here.

The pixel shifting part comprises a horizontal pixel shifting set having a liquid crystal cell 17A and a birefringent plate 18A and a vertical pixel shifting set having a liquid crystal cell 17B and a birefringent plate 18B for horizontal and vertical four-pixel shifting. Images displayed on the transmissive LCD 16 are projected and displayed on a screen 19 via the pixel shifting part and projection optical system 4.

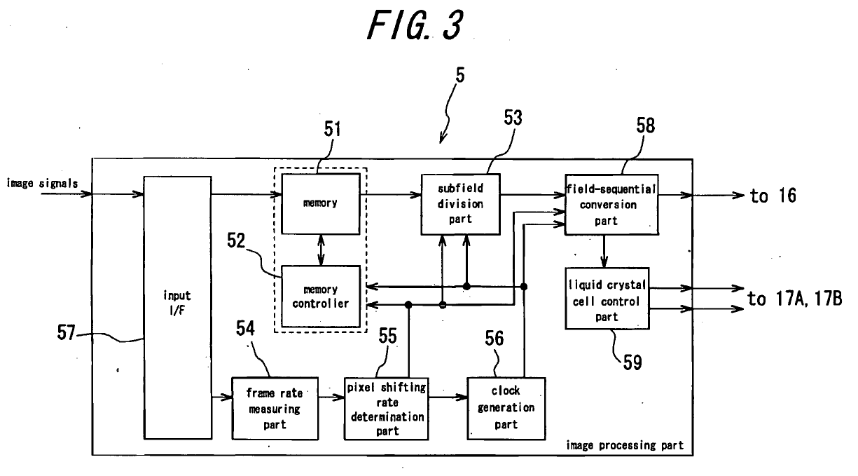

FIG. 3 is a block diagram showing the core part structure of the image processing part 5 shown in FIG. 2. The image processing part 5 has a memory 51, a memory controller 52, a subfield division part 53, a frame rate measuring part 54, a pixel shifting rate determination part 55, a clock generation part 56, an input interface (also termed the input I/F hereafter) 57 receiving input image signals and extracting the clock, horizontal synchronizing signals (also termed HD hereafter), vertical synchronizing signals (also termed VD hereafter), and data, an field-sequential conversion part 58 splitting subfield image data divided by the subfield division part 53 into R, G, and B color data, and a liquid crystal cell control part 59 controlling the operation of the liquid crystal cells 17A and 17B of the pixel shifting part in sync with subfields.

In the image processing part 5, the input I/F 57 extracts the clock, HD, VD, and data from input image signals and writes them in the memory 51. Frame image data are sent from the memory 51 to the subfield division part 53, where each frame data are divided into four subfield image data. The subfield image data are split into R, G, and B color data by the field-sequential conversion part 58 and supplied to the transmissive LCD 16 via a not-shown transmissive LCD controller. Signals are supplied to the liquid crystal cell control part 59 in sync with subfields to control the operation of the liquid crystal cells 17A and 17B of the pixel shifting part.

The memory 51 has a buffer for example for three frames, the reading/writing of which is controlled by the memory controller 52. The image processing part 5 has a not-shown color wheel control part controlling the rotation of the color wheel 13 in sync with color data split by the field-sequential conversion part 58.

On the other hand, the VD extracted by the input I/F 57 is also supplied to the frame rate measuring part 54, where the input frame rate (frame frequency, which is also termed FD hereafter) is measured based on sequential VD. The measurement result is transferred to the pixel shifting rate determination part 55.

The pixel shifting rate determination part 55 calculates as the pixel shifting rate a multiplication factor for the received clock in input image signals that is extracted by the input I/F 57 based on the field sequential rate of the transmissive LCD 16, number of colors separated by the color wheel 13, number of subfields divided by the subfield division part 53, and FD measured by the frame rate measuring part 54. The calculation result is supplied to the clock generation part 56.

The clock generation part 56 multiplies the received clock extracted by the input I/F 57 by the clock multiplication factor from the pixel shifting rate determination part 55. The clock in sync with the multiplied received clock is supplied to the memory 51, memory controller 52, subfield division part 53, and field-sequential conversion part 58 as the reference clock.

The pixel shifting rate determination part 55 calculates the subfield frame rate based on the field sequential rate and number of separated colors and calculates the display frame rate based on the subfield frame rate and number of divided subfields. The calculation results of the subfield frame rate and display frame rate are supplied to the memory controller 52, subfield division part 53, and field-sequential conversion part 58.

A not-shown interpolating part interpolating image signals is provided between the input I/F 57 and memory 51 and a not-shown data processing part processing image data such as enhancing/gamma processing is provided between the memory 51 and subfield division part 53. These are known techniques and not explained here.

Operation of this reference example will be explained hereafter. Here, it is assumed that input image signals are 1080i and the transmissive LCD 16 has an effective size of XGA. The 1080i presents image signals having an effective pixel size of 1920×1080 and interlaced at 60 Hz. Image signals other than the 1080i can easily be applicable and are not explained here.

First, the input I/F 57 alternately receives odd fields and even fields of image signals 1080i and writes them in the memory 51 as a screen of image signals having an effective pixel size of 1920×1080. This process can be done with an additional memory between the input I/F 57 and memory 51 or using an IP conversion controller.

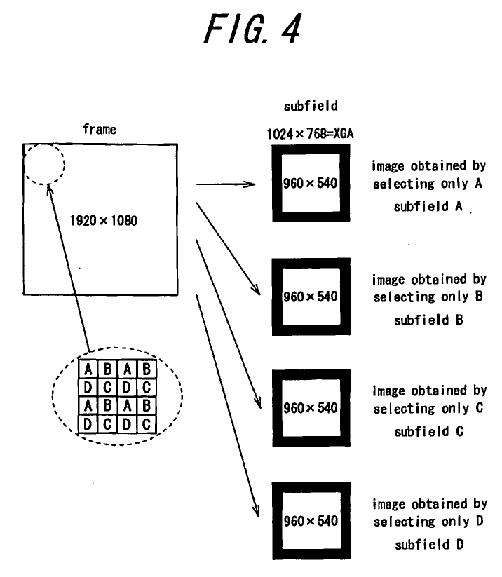

Then, the 1920×1080 image signals written in the memory 51 are divided into four 960×540 subfields A to D by the subfield division part 53 as shown in FIG. 4.

Here, the transmissive LCD 16 has a size of XGA (1024×768). The transmissive LCD 16 has more effective pixels than the input image when the 1920×1080 image signals are divided into four subfields A to D. Therefore, in this reference example, the subfields are created with data masked in black as shown in FIG. 4. Then, the created subfields A to D are sent to the field-sequential conversion part 58, where they are split into R, G, and B color data and sent to the transmissive LCD 16. Data filling the extra pixels of the transmissive LCD 16 are not restricted to data masked in black. For example, They can be displayed as any data using the not-shown interpolating part preceding the subfield division part 53.

On the other hand, the frame rate measuring part 54 measures and acknowledges that the input image signals are 1080i interlaced at 60 Hz based on the VD and field information from the input I/F 57, obtaining the information that the input frame rate (FD) of both odd and even fields together is 30 Hz. The frame rate measurement result (30 Hz) is sent to the pixel shifting rate determination part 55.

The pixel rate determination part 55 calculates the input image signal clock multiplication factor, subfield frame rate, and display frame rate using the following equations (1), (2), and (3), respectively.

$$\begin{matrix}Clock multiplication factor = \frac{( \frac{field sequential rate ( FS )}{number of seperated colors ( C )} )}{input frame rate ( FD ) \times \frac{mber of divided subfields ( S )}{{2}^{n}}} \\ n : 0 ( four \text{-} pixel shifting ) , 1 ( two \text{-} pixel shifting ) & ( 1 ) \\ Sub field frame rate = \frac{field sequential rate ( FS )}{number of seperated colors ( C )} & ( 2 ) \\ Display frame rate = \frac{( \frac{field sequential rate ( FS )}{number of seperated colors ( C )} )}{number of divided subfields ( S )} & ( 3 )\end{matrix}$$

In this reference example, FD=30, S=4, FS=480 Hz, C=3, and n=0, whereby the calculation results of the above equations (1), (2), and (3) are as shown below. The field sequential rate is an approximate value for display colors and does not match the area ratio of the color wheel 13. In other words, in practice, R light emission time is longer and G light emission time is shorter than R light emission time in some cases; however, unlike this, an approximate value obtained on the assumption that the R, G, and B emission times are all equal is used.

$$Clock multiplication factor = \frac{( \frac{480}{3} )}{30 \times \frac{4}{{2}^{0}}} = \frac{160}{120} = \\ Sub field frame rate = \frac{480}{3} = 160$$

$$Display frame rate = \frac{( \frac{480}{3} )}{4} = 40$$

The clock multiplication factor (4/3) calculated by the pixel shifting rate determination part 55 is supplied to the clock generation part 56. The received clock in the input image signals that is extracted by the input I/F 57 is multiplied by 4/3. The clock in sync with the multiplied received clock is supplied to the memory 51, memory controller 52, subfield division part 53, and field-sequential conversion part 58 as the reference clock. The subfield frame rate and display frame rate calculated by the pixel shifting rate determination part 55 are supplied to the memory controller 52, subfield division part 53, and field-sequential conversion part 58.

The frame rate measuring part 54 and pixel shifting determination part 55 can easily be constituted by a microcomputer using a CPU. The clock generation part 56 can easily be constituted by a PLL circuit.

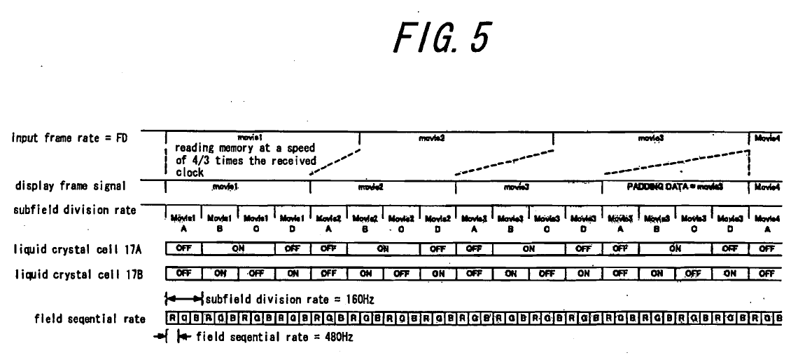

FIG. 5 is a timing chart showing the operation of the image display device of this reference example.

In FIG. 5, the FR=30 Hz, subfield frame rate (subfield division rate)=160 Hz, subfield sequential rate=480 Hz, and display frame rate (display frame signal)=40 Hz.

In this reference example, the memory 51 has a buffer for three frames. The memory controller 52 reads the memory 51 with a faster (4/3 times) clock generated by the clock generation part 56 than the received clock. Therefore, images to be displayed run out. Then, in FIG. 5, “Movie 3” is read twice for adjustment in relation to the display frame rate (the image data embedded for such adjustment is termed “padding data” hereafter).

In FIG. 5, the adjustment in relation to the display frame rate is made at three-frame memory intervals. The adjustment can be made using a larger frame memory. The “padding data” is not restricted to “Movie 3” being read twice. According to the display image, some input image (for example Movie 2) can be read twice.

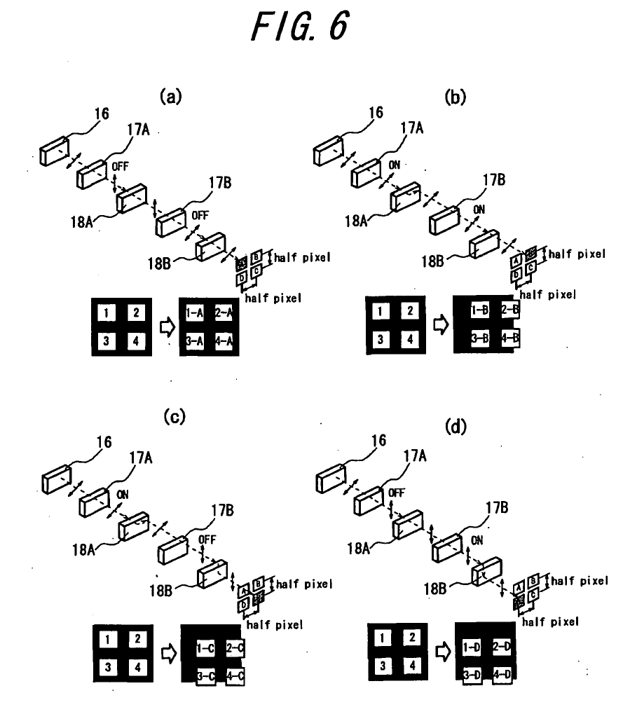

FIG. 6 (a) to (d) are illustrations for explaining the four-pixel shifting in this reference example. In FIG. 6 (a), both the horizontal pixel shifting liquid crystal cell 17A and the vertical pixel shifting liquid crystal cell 17B are turned off. In this state, it is assumed that light emerging from the transmissive LCD 16 has a horizontal polarization plane. Then, rotated by 90° by the liquid crystal cell 17A, the light has a vertical polarization plane and transmits the birefringent plate 18A with no pixel shifting. Then, rotated by 90° by the liquid crystal cell 17B, the light has a horizontal polarization plane and transmits the birefringent plate 18B with no pixel shifting. Consequently, the pixel position after passing through the pixel shifting means is the same as the pixel position before passing through the pixel shifting means, namely the position A if focusing on one pixel.

Subsequently, when both liquid crystal cells 17A and 17B are turned on, as shown in FIG. 6 (b), light from the transmissive LCD 16 transmits the liquid crystal cell 17A with no rotation of the polarization plane, is shifted horizontally by a half pixel pitch by the birefringent plate 18A, transmits the liquid crystal cell 17B with no rotation of the horizontal polarization plane, and transmits the birefringent plate 18B with no pixel shifting. Consequently, the pixel position after passing through the pixel shifting part is shifted horizontally by a half pixel pitch to the position B.

Then, when the liquid crystal cell 17B is turned off, as shown in FIG. 6 (c), the horizontal polarization plane shifted horizontally by a half pixel pitch by the birefringent plate 18A is rotated by 90° by the liquid crystal cell 17B to a vertical polarization plane. The vertical polarization plane is shifted vertically by a half pixel pitch by the birefringent plate 18B. Consequently, the pixel position after passing through the pixel shifting part is shifted horizontally and vertically by a half pixel pitch to the position C.

Then, when the liquid crystal cell 17A is turned off and the liquid crystal cell 17B is turned on, light from the transmissive LCD 16 has the polarization plane rotated by 90° by the liquid crystal cell 17A to a vertical polarization plane, transmits the birefringent plate 18A with no pixel shifting, transmits the liquid crystal cell 17B with the vertical polarization plane unchanged, and is shifted vertically by a half pixel pitch by the birefringent plate 18B. Consequently, the pixel position after passing through the pixel shifting part is shifted vertically by a half pixel pitch to the position D.

In the above operation, the four-pixel shifting in which each pixel position of the transmissive LCD 16 is horizontally and vertically shifted by a half pixel pitch leads to improved resolution.

As described above, in this reference example, the spatial light modulation part is constituted by a relatively inexpensive and affordable transmissive LCD 16 having a field sequential rate of 480 Hz and the pixel shifting part performs the pixel shifting. Therefore, the subfield division rate depending on the pixel shifting can be increased and the flicker due to wobbling (pixel shifting) can be less visible. Furthermore, the transmissive LCD 16 displays images along with adjustment in relation to the display frame at certain fixed intervals, reducing color breakup.

### Reference Example 2

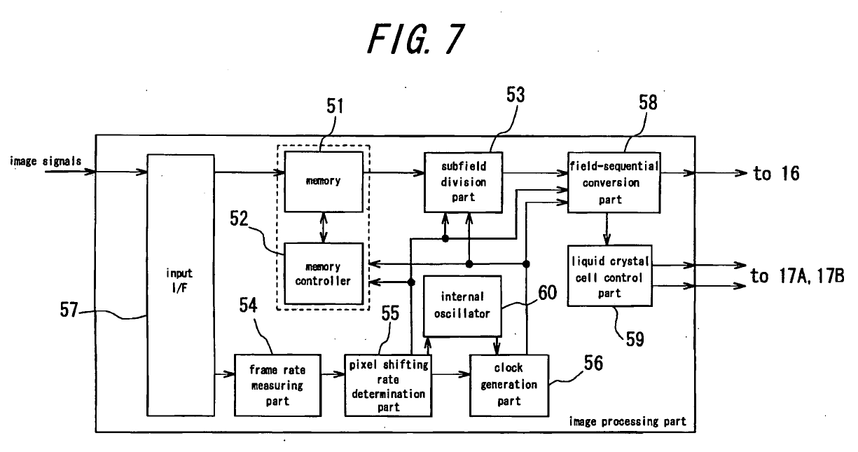

FIG. 7 is a block diagram showing the core part structure of the image processing part of the image display device of Reference Example 2 developed with the present invention.

The image processing part 5 of this reference example comprises an internal oscillator 60 having a quartz oscillator. The output oscillation of the internal oscillator 60 is demultiplied based on the clock multiplication factor calculated by the pixel shifting rate determination part 55 to generate signals corresponding to a desired HD. The signals are supplied to the clock generation part 56 to generate a reference clock. The other structure and operation is the same as in Reference Example 1.

As described above, the internal oscillator 60 is provided and its output is multiplied based on the calculation result from the pixel shifting rate determination part 55 to generate a reference clock. In this way, a reference clock with less jitter can be generated compared with a reference clock generated by multiplying a clock extracted from input image signals. Therefore, more clear images can be displayed.

### Reference Example 3

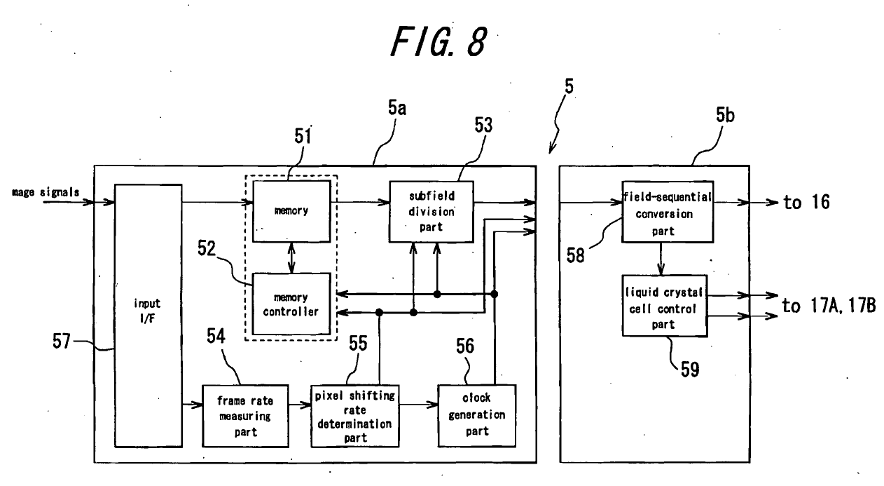

FIG. 8 is a block diagram showing the core part structure of the image processing part of the image display device of Reference Example 3 developed with the present invention.

In this reference example, the image processing part 5 of Reference Example 1 is divided into two parts: the first image processing part 5a consists of the memory 51, memory controller 52, subfield division part 53, frame rate measuring part 54, pixel shifting rate determination part 55, clock generation part 56, and input I/F 57 and the second image processing part 5b consists of the field-sequential conversion part 58 and liquid crystal cell control part 59. The two parts are connectable by a not-shown connection cable.

The above structure allows the second image processing part 5b to be provided to the main body of the image display device and the first image processing part 5a to be provided separately from the image display device. Therefore, the image display device can advantageously be downsized and produced at reduced cost.

Reference Example 3 can be applied to Reference Example 2. In such a case, the internal oscillator 60 can be included in the first image processing part 5a.

### Reference Example 4

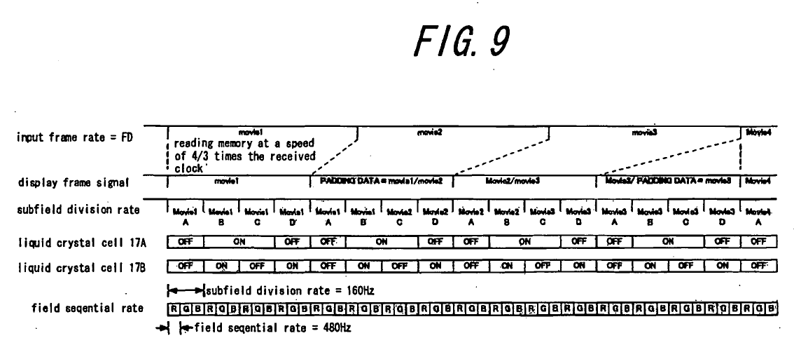

FIG. 9 is a timing chart showing the operation of the image display device of Reference Example 4 developed with the present invention.

In this reference example, the “padding data” is inserted on a subfield basis, not on a frame basis as described in Reference Example 1, in order to adjust displayed images at fixed intervals for complying with the pixel shifting.

The image data written in the memory 51 are inserted as the “padding data” on a subfield basis. In this way, images can be displayed without making the viewer sense something is wrong particularly when motion pictures are displayed.

### Reference Example 5

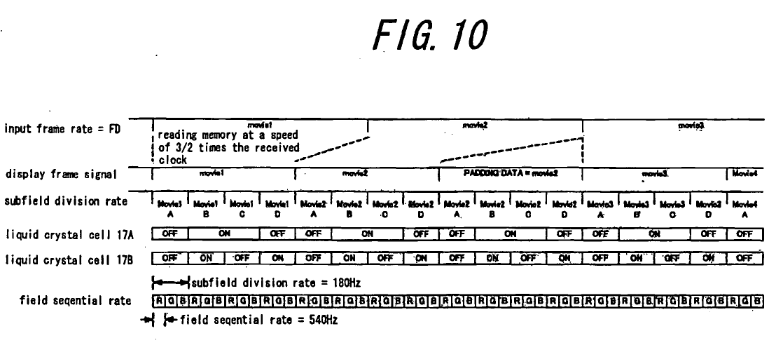

FIG. 10 is a timing chart showing the operation of the image display device of Reference Example 5 developed with the present invention.

In this reference example, the transmissive LCD 16 of Reference Example 1 is replaced with one having a field sequential rate of 540 Hz, which is higher than 480 Hz and relatively inexpensive and affordable.

Therefore, in this reference example, the clock multiplication factor, subfield frame rate, and display frame rate calculated by the pixel shifting rate determination part 55 of the image processing part 5 are as follows.

$$Clock multiplication factor = \frac{( \frac{540}{3} )}{30 \times \frac{4}{{2}^{0}}} = \frac{180}{120} = \frac{3}{2}$$

$$Sub field frame rate = \frac{540}{3} = 180$$

$$Display frame rate = \frac{( \frac{540}{3} )}{4} = 45$$

As shown above, the clock multiplication factor is 3/2 in this reference example. Therefore, in FIG. 10, “Movie 2” is read and displayed twice for adjustment in relation to input image signals.

The transmissive LCD 16 of this reference example has a field sequential rate of 540 Hz. Then, 45 Hz display frame signals can be used. Thus, the flicker due to pixel shifting can be less visible and color breakup can be reduced.

### Reference Example 6

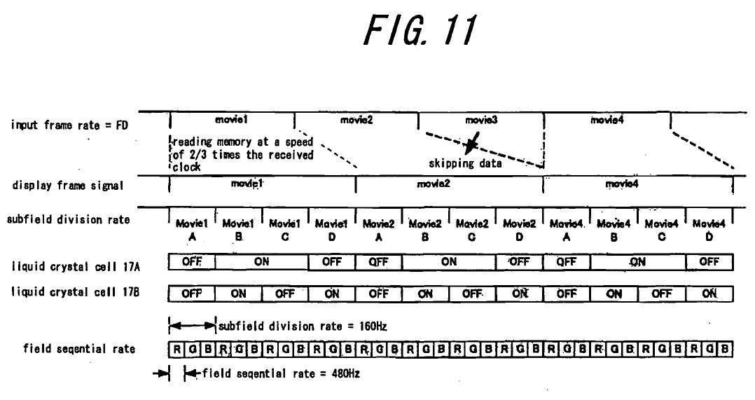

FIG. 11 is a timing chart showing the operation of the image display device of Reference Example 6 developed with the present invention.

In this reference example, the input image signal frame rate FD of Reference Example 1 is modified to 60 Hz as in PC applications. In this case, the clock multiplication factor, subfield frame rate, and display frame rate calculated by the pixel shifting rate determination part 55 of the image processing part 5 are as follows.

$$Clock multiplication factor = \frac{( \frac{480}{3} )}{60 \times \frac{4}{{2}^{0}}} = \frac{160}{240} = \frac{2}{3}$$

$$Sub field frame rate = \frac{480}{3} = 160$$

$$Display frame rate = \frac{( \frac{480}{3} )}{4} = 40$$

As shown above, the display frame signal rate of this reference example is 40 Hz, which is lower than the input frame rate of 60 Hz. Therefore, as shown in FIG. 11, the clock is generated in a similar sequence to skip and not display “Movie 3” for adjustment between input image signals and display frames.

When the input image signal FD is 75 Hz, an overtaking control can be conducted using a memory for adjustment between display frame signals and input image signals. More specifically, an overtaking control for altering 75 Hz input to 60 Hz is conducted on a memory.

### Embodiment 1

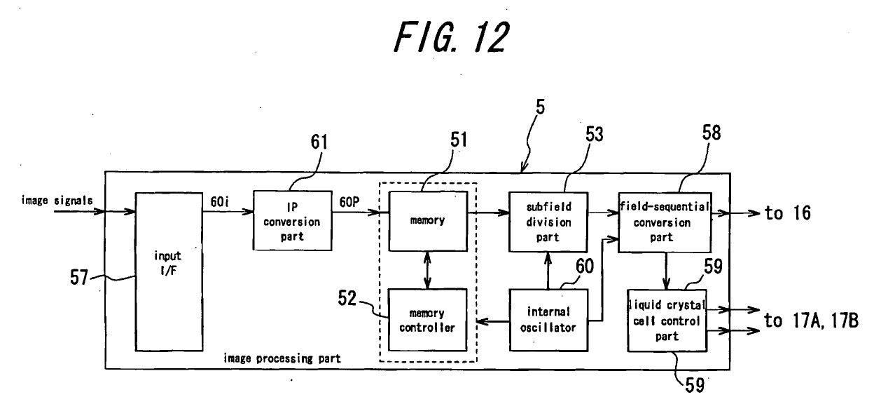

FIG. 12 is a block diagram showing the core part structure of the image processing part of the image display device of Embodiment 1 of the present invention.

In this embodiment, the frame rate measuring part 54, pixel shifting rate determination part 55, and clock generation part 56 are eliminated from the image processing part 5 of Reference Example 1 and the image processing part 5 comprises the memory 51, memory controller 52, subfield division part 53, input I/F 57, field-sequential conversion part 58, liquid crystal cell control part 59, internal oscillator 60, and IP conversion part 61, and the transmissive LCD 16 has a field sequential rate of 540 Hz.

In the case below, input image signals are 1080i and the IP conversion part 61 is motion-adaptive. The input I/F 57 receives 1080i input image signals and outputs them as 60 Hz interlaced image signals (60i) without change. They are converted to 60 Hz progressive signals (60P) by the IP conversion part 61 and written in the memory 51.

On the other hand, the internal oscillator 60 generates dot clock in accordance with the 540 Hz field sequential rate. The memory 51 is read with this clock, tripled by the field-sequential conversion part 58, and transferred to the transmissive LCD 16.

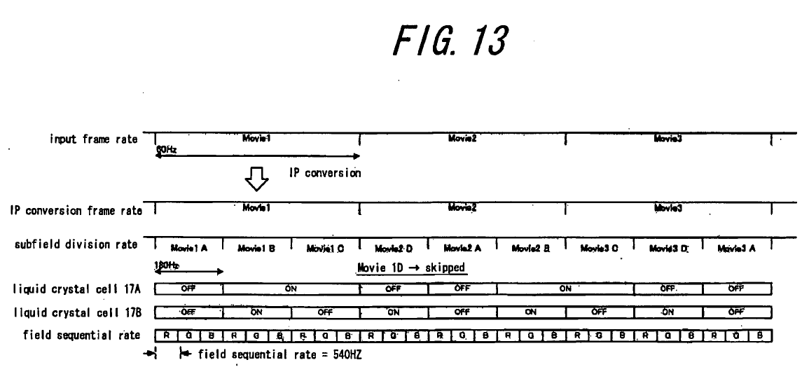

FIG. 13 is a timing chart showing the operation in the above case. One of the four subfields in each frame is skipped for adjustment between display frame signals and input image signals.

The image processing part 5 of this reference example advantageously has a simple and inexpensive structure compared with the above described reference examples.

### Reference Example 7

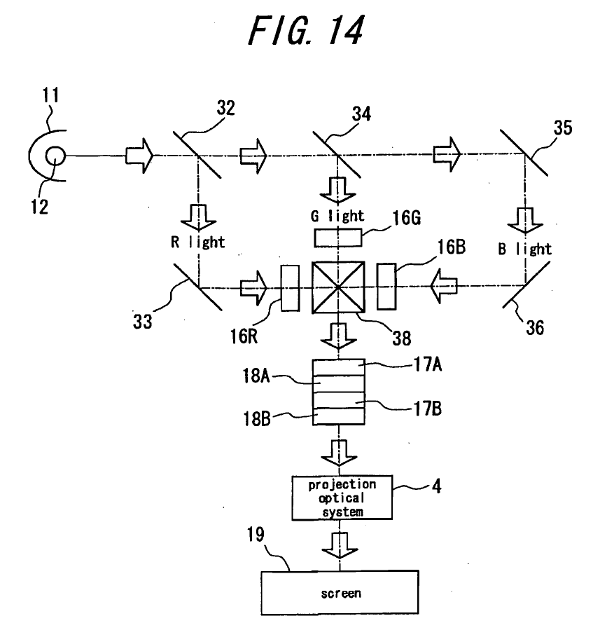

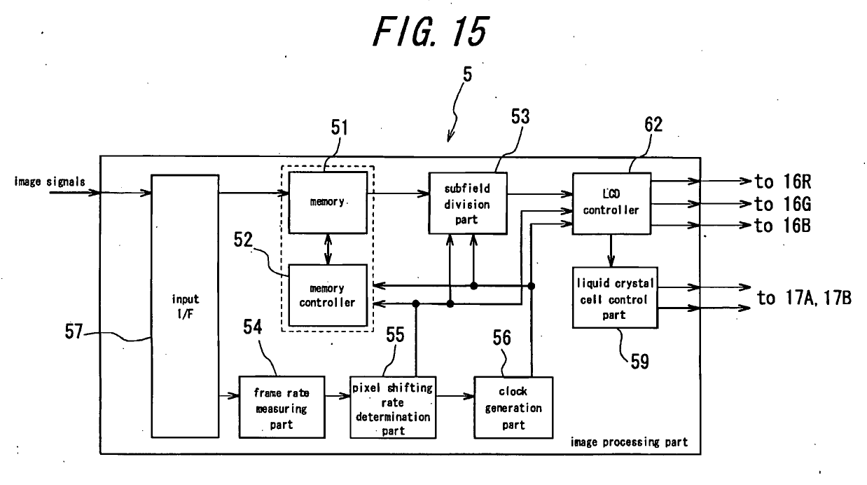

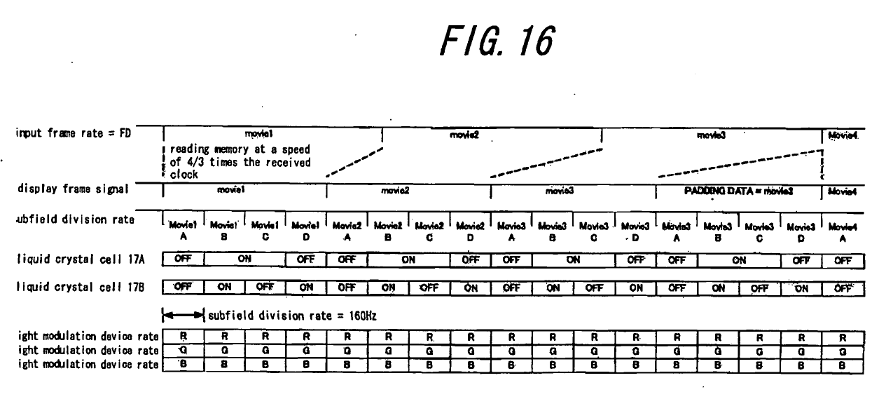

FIGS. 14 to 16 show Reference Example 7 developed with the present invention. FIG. 14 is an illustration schematically showing the structure of the image display device. FIG. 15 is a block diagram showing the structure of the image processing part. FIG. 16 is a timing chart showing the operation.

This image display device is of a three-plate type using three transmissive LCDs. As shown in FIG. 14, illumination light from a light source part having a white light source 11 and a reflector 12 enters a dichroic mirror 32, where R light is reflected and other lights are transmitted. The separated R light is reflected by a mirror 33 to enter an R transmissive LCD 16R. Among the illumination light transmitted through the dichroic mirror 32, G light is reflected by a dichroic mirror 34 and B light is transmitted through the dichroic mirror 34. The G light enters a G transmissive LCD 16G. The B light enters a B transmissive LCD 16B via mirrors 35 and 36. Here, the illumination optical system such as a P/S converter is not shown.

Images modulated and formed by the R, G, and B transmissive LCDs 16R, 16G, and 16B are combined by a combining prism 38 and projected and displayed on a screen 19 by a projection optical system 4 via a pixel sifting part comprising a horizontal pixel shifting set having a liquid crystal cell 17A and a birefringent plate 18A and a vertical pixel shifting set having a liquid crystal cell 17B and a birefringent plate 18B where the image is subject to the horizontal and vertical four-pixel shifting as in the above described embodiment and reference examples.

Furthermore, as shown in FIG. 15, the image processing part 5 has an LCD controller 62 in place of the field-sequential conversion part 58 in the structure shown in FIG. 3. Image data are simultaneously transferred to the transmissive LCDs 16R, 16G, and 16B from the LCD controller 62.

Operation of this reference example will be described hereafter. Here, the transmission LCDs 16R, 16G, and 16B operate at 160 Hz (light modulation device rate) and input image signals are 1080i.

First, the input I/F 57 alternately receives odd and even fields of 1080i image signals and writes them in the memory 51 as a screen of image signals. The input I/F 57 also extracts the clock, HD, and VD. The frame rate measuring part 54 measures and finds that the input frame rate (FD) is 30 Hz. The pixel shifting rate determination part 55 calculates the input image signal clock multiplication factor, subfield frame rate, and display frame rate using the following equations (4), (5), and (6), respectively.

$$\begin{matrix}Clock multiplication factor = \frac{light modulation device rate ( M )}{input frame rate ( FD ) \times \frac{number of divided subfields ( S )}{{2}^{n}}} \\ n : 0 ( four \text{-} pixel shifting ) , 1 ( two \text{-} pixel shifting ) & ( 4 ) \\ Sub field frame rate = light modulation device rate ( M ) & ( 5 ) \\ Display frame rate = \frac{light modulation device rate ( M )}{number of divided subfields ( S )} & ( 6 )\end{matrix}$$

In this reference example, the clock multiplication factor is 4/3, subfield frame rate is 160 Hz, and display frame rate is 40 Hz.

The clock generation part 56 multiply the received clock in input image signals that is extracted by the input I/F 57 by the clock multiplication factor calculated by the pixel shifting rate determination part 55. The multiplied clock is supplied to the memory 51, memory controller 52, subfield division part 53, and LCD controller 62 as the reference clock. The subfield frame rate and display frame rate calculated by the pixel shifting rate determination part 55 are supplied to the memory controller 52, subfield division part 53, and LCD controller 62.

In this way, the image signals written in the memory 51 are read with the reference clock from the clock generation part 56 and divided into four subfields A to D by the subfield division part 53. The divided subfield image signals are transferred to the LCD controller 62 and simultaneously written in the transmissive LCDs 16R, 16G, and 16B.

FIG. 16 is a timing chart showing the operation of the image display device of this reference example.

In FIG. 16, the FD=30 Hz, subfield frame rate (subfield division rate)=160 Hz, and display frame rate (display frame signals)=40 Hz.

Furthermore, in this reference example, the memory 51 has a buffer for three frames as in Reference Example 1. The memory controller 52 reads the memory 51 with the clock generated by the clock generation part 56, which is faster (4/3 times) than the received clock. Therefore, images to be displayed run out. Then, in FIG. 16, “Movie 3” is read twice for adjustment in relation to the display frame rate as in Reference Example 1.

In FIG. 16, the adjustment in relation to the display frame rate is performed at three frame memory intervals. The adjustment can be done using a larger frame memory. Furthermore, the “padding data” is not restricted to “Movie 3” being read twice. Some input image (for example Movie 2) can be read twice in accordance with the displayed image.

In this reference example, the subfield division rate depending on the pixel shifting can be increased and the flicker due to wobbling (pixel shifting) can be less visible.

The present invention is not confined to the above embodiment and various modifications and changes can be made. For example, in Embodiment 1, the field-sequential conversion part 58 and liquid crystal cell control part 59 of the image processing part 5 can be separated from the other components as in Reference example 3 shown in FIG. 8. Similarly, in FIG. 15, the LCD controller 62 and liquid crystal cell control part 59 of the image processing part 5 can be separated from the other components. Furthermore, in FIG. 15, an internal oscillator can be provided to generate a reference clock.

Furthermore, in the above embodiment, the pixel shifting rate determination part 55 of the image processing part 5 calculates the clock multiplication factor, subfield frame rate, and display frame rate. When the field sequential rate of the spatial light modulation device used is known (in the case of an field-sequential single plate system) or when the light modulation device rate is known (in the case of a multiple plate system), only the clock multiplication factor is calculated. Then, the circuit size of the image processing part 5 can be reduced, leading to reduced cost.

The spatial light modulation device is not restricted to those having a field sequential rate of 480 Hz or 540 Hz. Those having a field sequential rate of 600 Hz or 840 Hz can be used.

In the above embodiment, the pixel shifting means conducts the four-pixel shifting. The present invention is effectively applicable to the two-pixel shifting. Furthermore, the spatial light modulation device is not restricted to transmissive LCDs and can be reflective LCDs or DMDs. In the case of a multiple plate system, the present invention is effectively applicable to two, four, or more plates beside three plates. The pixel shifting part is not restricted to combinations of liquid crystal cells and birefringent plates. For example, a known structure disclosed in the Japanese Laid-Open Patent Application Publication No. 2003-279924 or a pixel shifting means using a mechanical structure can be used.

Furthermore, the present invention is not restricted to color display and effectively applicable to black and white display.

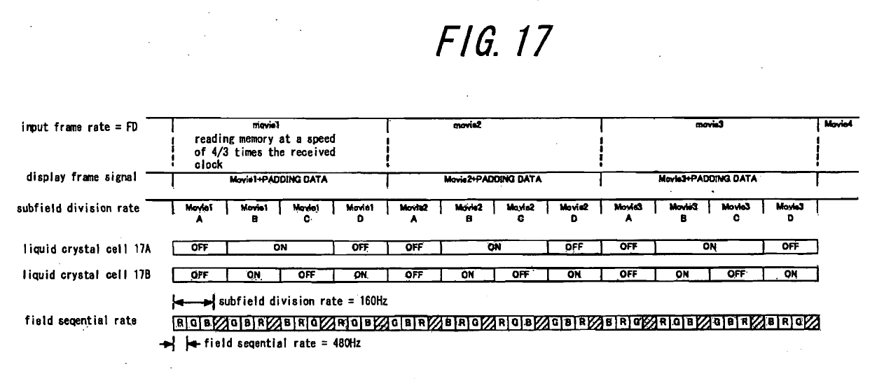

When the pixel shifting part has a low response speed and data to be written in the spatial light modulation device run out, data adjustment on a subfield basis leads to reduced color breakup. For example, when the liquid crystal cells 17A and 18B constituting the pixel shifting part have a low response speed in the structure shown in FIG. 2, the display frame signals are set for the same rate as the input frame rate (30 Hz) and the memory 51 is read with a reference clock that is 4/3 times faster than the received clock to fill the deficit of data to be written in the transmissive LCD 16 with white or black “padding data” on a subfield basis as shown by hatched lines in the timing chart of FIG. 17. Here, again, the reference clock can be generated from the received clock or by an internal oscillator.

As described above, filling with the white or black “padding data” on a subfield basis for adjustment in relation to input image signals, a large frame memory is unnecessary unlike Reference Example 1. Color breakup can be reduced in an inexpensive structure.

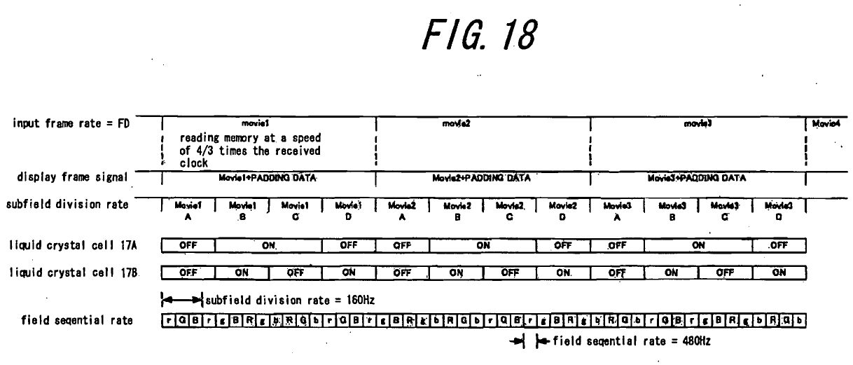

In place of the white or black “padding data,” the corresponding field-sequential color can be “halved” and written for adjustment to reduce color breakup as shown in FIG. 18. More specifically, if the first subfield data to be written is “R,” the “R” is halved to “r,” which is written. When the next “R” is written, the other “half” or “r” is written. “G” and “B” are similarly controlled.

In such a case, the field-sequential conversion part 58 of the image processing part 5 has to have a field memory. However, it is advantageous in cost compared with a large frame memory being provided as in Reference Example 1.

With the response speed of the pixel shifting part being stored in the pixel shifting rate determination part 55 of the image processing part 5 in advance, the above described controls can appropriately be selected according to input image signals.

What is claimed is:

1. An image display device in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image,
wherein the device has an image processing part supplying to said spatial light modulation part a smaller or larger number of said subfield images than the number of said divided subfield images so that the display frame rate of said spatial light modulation part is equal to the frame rate of said input image signals.

2. The image display device according to claim 1, wherein said pixel shifting part performs the four pixel shifting; and said image processing part supplies to said spatial light modulation part three subfield images in a frame period of said input image signals.

3. The image display device according to claim 2, wherein the frame rate of said input image signals is 60 Hz and the display frame rate of said subfield images is 180 Hz.

4. The image display device according to claim 1, wherein said pixel shifting part shifts pixels in a specific shifting order and said image processing part supplies to said spatial light modulation part subfield images corresponding to the shifted pixel positions of sequentially supplied frame images in accordance with the pixel position shifted by said pixel shifting part.

5. An image display method in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image,
wherein a larger or smaller number of said subfield images than the number of said divided subfield images are supplied to said spatial light modulation part to display an image so that the display frame rate of said spatial light modulation part is equal to the frame rate of said input image signals.

6. An image display method in which each frame image in input image signals is divided into multiple subfield images according to the number of pixels to be shifted by a pixel shifting part, said subfield images are supplied to an spatial light modulation part to spatially modulate light from a light source part, and the pixels of said spatial light modulation part are shifted by said pixel shifting part in sync with said subfield images to display an image,
wherein said pixel shifting is performed in a specific shifting sequence and a frame image in said input image signals is updated at least once in a cycle of said pixel shifting.
